(19) United States
(12) Patent Application Publication
(10) Pub. No.: US 2007/0202909 A1
(43) Pub. Date: Aug. 30, 2007

(54) METHOD FOR PUSH-TO-TALK OVER MOBILE COMMUNICATION DEVICES

(76) Inventor: Chi-Chang Liu, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 11/674,627

(22) Filed: Feb. 13, 2007

(30) Foreign Application Priority Data
Feb. 27, 2006 (TW) 095106677

(51) Int. Cl. H04B 7/00

(52) U.S. Cl. 455/518

(57) ABSTRACT

A method makes it possible to establish PTT connections among mobile communication devices that belong to different service groups of different servers. The mobile communication devices are capable of directly transmitting signals and data to each other in a peer-to-peer manner according to session initiation protocol (SIP). The permission to speak is transferred among the mobile communication devices by transmitting specific signals according to predetermined paths of signal delivery.

### BACKGROUND OF THE INVENTION

1. Field of the Invention

The present invention relates to a method for push-to-talk (PTT) over mobile communication devices, and more particularly, to a method for PTT over mobile communication devices according to session initiation protocol (SIP).

2. Description of the Prior Art

In recent years, because of rapid progress of science and technology, a push-to-talk (PTT) function has been included in more and more cellular phones. The PTT function makes cellular phones operate as walkie-talkies. When two or more users communicate to each other by using cellular phones, they can make other users in the same server be capable of listening to their speech by pushing pick-up buttons on their cellular phones.

In the prior art, the PTT function is accomplished by setting up a client-server structure. In the client-server structure, there is a server for managing the statuses of all users, delivering messages and data received from the users, and arbitrating possible conflicts and problems among the communications of the users. Any user who wants to use the PTT function has to register his/her cellular phone with the server. Then the server provides PTT service to the cellular phone assigned to the user according to the registration data of the cellular phone.

Please refer to FIG. 1, which is a schematic diagram illustrating a procedure of PTT according to the prior art. All transmission of data and messages among the cellular phones has to be handled by the server 110. When the cellular phone 130 wirelessly connects with the server 110 via the IP (Internet protocol) network 120, the cellular phone 130 can send invitation signals to other cellular phones 140 and 150 that are in the same service group as the cellular phone 130 via the server 110. If any cellular phone 140 or 150 accepts the invitation of the cellular phone 130, the cellular phone 140 or 150 sends an acceptance signal to the cellular phone 130 via the server 110 to establish connection between the cellular phones 130,140 or 130,150. If the cellular phone 140 or 150 is off-line or rejects the invitation of the cellular phone 130, and the cellular phone 130 fails to receive the acceptance signal from the cellular phone 140 or 150 and to establish connection with the cellular phone 140 or 150. When the cellular phone 130 receives the acceptance signal, the cellular phone 130 obtains permission to speak. And then the user of the cellular phone 130 can speak to the cellular phone 140 or 150 via the server 110. When the user of the cellular phone 130 finishes speaking and releases the pick-up button of the cellular phone 130, the cellular phone 130 transmits a call release signal to the server 110 to switch the conversation into an idle mode. When the conversation is in the idle mode, any online cellular phone 140 or 150 can transmit a call request signal to the server 110 to obtain permission to speak. In such a manner the cellular phones 130-150 can obtain permission to speak and release such permission.

However, because of different Internet service providers (ISPs), operators, or carriers for providing PTT service, cellular phones of different servers cannot communicate to each other using the PTT function. In addition, it is very time consuming and expensive to establish the same standard of PTT service between different servers.

### SUMMARY OF THE INVENTION

The present invention provides a method for push-to-talk (PTT) over mobile communication devices. The method comprises a first mobile communication device directly transmitting a call request signal to a second mobile communication device, the first mobile communication device and the second mobile communication device belonging to different servers; the second mobile communication device transmitting the call request signal to a first server; after the first server receiving the call request signal from the second mobile communication device, the first server transmitting a reception authority signal to a third mobile communication device and transmitting a call authority signal to the second mobile communication device, the second mobile communication device and the third mobile communication device belonging to the first server; and the second mobile communication device directly transmitting the call authority signal to the first mobile communication device.

The present invention also provides another method for push-to-talk (PTT) over mobile communication devices. The method comprises a first mobile communication device directly transmitting a call request signal to a server; the server transmitting a call authority signal to a first mobile communication device and transmitting a reception authority signal to a second mobile communication device, the first mobile communication device and the second mobile communication device belonging to the server; and the second mobile communication device directly transmitting the reception authority signal to a third mobile communication device, the second mobile communication device and the third mobile communication device belonging to different servers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a procedure of PTT according to the prior art.

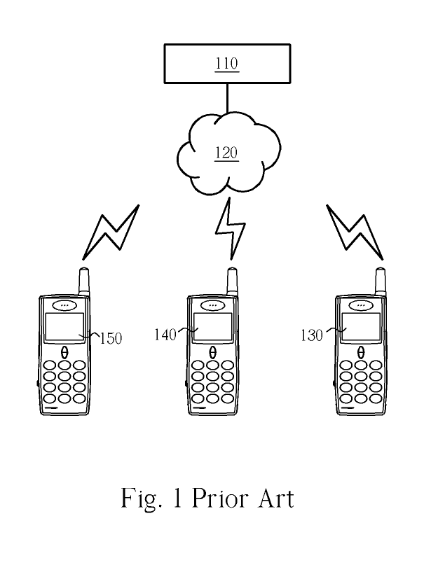

FIG. 2 is a schematic diagram illustrating a procedure of PTT according to the present invention.

FIG. 3 is a flow chart for illustrating the process to establish PTT connections among the cellular phones shown in FIG. 2.

### DETAILED DESCRIPTION

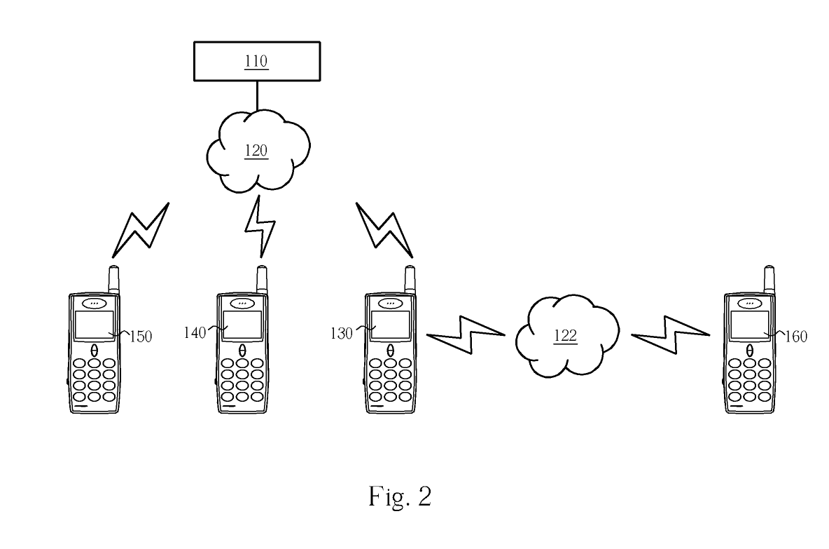

Please refer to FIG. 2, which is a schematic diagram illustrating a procedure of PTT according to the present invention. In the embodiment, the mobile communication devices including PTT function are cellular phones. However, the mobile communication devices are not limited by cellular phones and can be mobile computers or PDAs with wireless communication ability and so on. The cellular phone 160 does not belong to any service group of the server 110 and may belong to a service group of another server or may not even belong to any service group of a server, i.e., the cellular phone 160 may not be registered with any server. The cellular phones 130, 140, and 150 belong to service groups of the server 110. The cellular phones 130 and 160 can operate according to session initiation protocol (SIP). The cellular phones 130 and 160 can directly transmit signals and data to each other through the IP network 122 in a peer-to-peer manner according to SIP. The IP networks 120 and 122 can be networks provided by ISPs or public networks. SIP is standard communication protocol, and many operations on IP network, such as video conference, network phone, and instant message (IM), can be accomplished according to SIP. The format of SIP addresses is similar to that of an email address. For example, a SIP address may be “user@domain.com” where “user” is the username and “domain.com’ is the domain name. Because any SIP address is unique, data and signals can be quickly and effectively transmitted to a specific cellular phone with a definite SIP address according to SIP. In addition, SIP can be used to establish peer-to-peer communication between cellular phones belonging to different service groups of servers or between cellular phones that do not belong to any service group of server and without any assistance of the servers. Therefore, the cellular phone 160 is capable of establishing a PTT connection with the cellular phone 130 without assistance of the server 110. Moreover, the cellular phone 160 can communicate with the cellular phones 140 and 150 in a PTT manner with assistance of the cellular phone 130 and the server 110.

In the embodiment, when the cellular phone 160 that operates according to SIP begins to communicate with the cellular phone 140 in a PTT manner, the cellular phone 160 first establishes a PTT connection with the cellular phone 130, which also operates according SIP. For example, the cellular phone 160 sends an invitation signal to the cellular phone 130, and the cellular phone 130 sends an acceptance signal to the cellular phone 160 after receiving the invitation signal. A PTT connection between the cellular phones 130 and 160, hence, is established. Then, the cellular phone 130 can send an invitation signal to the cellular phone 140 via the server 110. If the cellular phone 140 accepts the invitation of the cellular phone 130, the cellular phone 140 sends an acceptance signal to the cellular phone 130 via the server 110 to establish a PTT connection with the cellular phone 130. In other words, the PTT connections among the cellular phones 130, 140, and 160 are established. However, the establishment of the PTT connections does not have to begin from the cellular phone 160 and may begin from the cellular phone 130 or 140. For example, the cellular phone 130 sends the invitation signal to the cellular phones 140 and 160, or the cellular phone 140 sends the invitation signal to the cellular phone 130 before the cellular phone 130 sends the invitation signal to the cellular phone 160. In addition, the cellular phone 130 can send the invitation signal to other cellular phones. For instance, the cellular phone 130 sends the invitation signal to the cellular phone 150, which belongs to another service group of the server 110, or sends the invitation signal to a cellular phone that does not belong to the service groups of the server 110 to establish more PTT connections.

In summary, the combinations of the processes for establishing PTT connections are various. No matter what cellular phone begins the establishment of the PTT connections, as long as the PTT connections have been established, any cellular phone 130, 140, or 160 can send a call request signal to request for connection to obtain the permit to speak. For example, when the user of the cellular phone 160 wants to speak, the cellular phone 160 sends a call request signal to the cellular phone 130 when the user pushes the pick-up button of the cellular phone 160. Then, the cellular phone 130 passes the call request signal to the server 110. When the server 110 receives the call request signal from the cellular phone 130, the server 110 sends a reception authority signal to the cellular phone 140 and a call authority signal to the cellular phone 130. Then, the cellular phone 130 passes the call authority signal to the cellular phone 160 so that the cellular phone 160 obtains the permit to speak and that the cellular phones 130 and 140 can silently listen to voice received from the cellular phone 160. When the user of the cellular phone 160 speaks, the cellular phone 160 transmits voice signal to the cellular phone 130. Then, the cellular phone 130 passes the speech to the server 110, and the server 110 sends the speech to the cellular phone 140. After the user of the cellular phone 160 finishes speaking, the cellular phone 160 sends a call release signal to the server 110 via the cellular phone 130 when the user of the cellular phone 160 releases the pick-up button of the cellular phone 160 to switch the conversation into an idle mode. When the server 110 receives the call release signal from the cellular phone 130, the server 110 transmits an idle mode signal to the cellular phones 130 and 140, and the cellular phone 140 passes the idle mode signal to the cellular phone 160. Then the conversation is switched into an idle mode.

In addition, when the conversation is switched into the idle mode, each of cellular phones 130, 140, or 160 can send a call request signal to obtain the permit to speak. Therefore, when the user of the cellular phone 140 wants to speak, the cellular phone 140 transmits a call request signal to the server 110. After the server 110 receives the call request signal from the cellular phone 140, the server 110 transmits a call authority signal to the cellular phone 140 and a reception authority signal to the cellular phone 130. Then, the cellular phone 130 passes the reception authority signal to the cellular phone 160. Therefore, the cellular phone 140 obtains the permit to speak, and the users of the cellular phones 130 and 160 can silently listen to the voice received from the cellular phones 140. When the user of the cellular phone 140 speaks, the cellular phone 140 transmits the speech to the server 110. Then, the server 110 passes the speech to the cellular phone 130, and the cellular phone 130 passes the speech to the cellular phone 160. After the user of the cellular phone 140 finishes speaking, the cellular phone 140 sends a call release signal to the server 110 to switch the conversation into an idle mode.

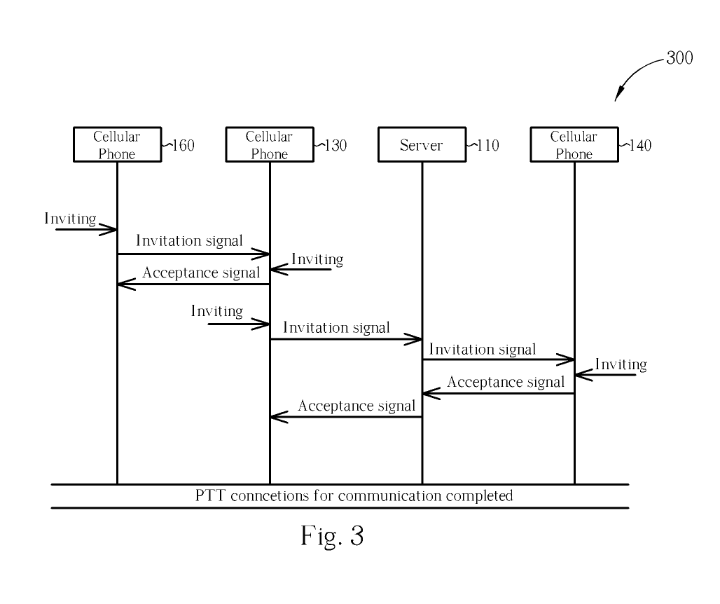

Please refer to FIG. 3, which is a flow chart 300 for illustrating the process to establish PTT connections among the cellular phones 130, 140, and 160 shown in FIG. 2. The flow chart 300 is used to illustrate one of the above embodiments, and redundant description will not be repeated. However, it should be noted that the present invention is not limited by the embodiment illustrated in the flow chart 300.

In summary, the present invention provides a method for push-to-talk over mobile communication devices. The cellular phone 160 directly communicates with the cellular phone 130 via the IP network 122 in a peer-to-peer way according to SIP, and the cellular phone 130 can communicate with the cellular phone 140 that belongs to the same service group of the server 110 in a PTT manner. In addition, the cellular phone 160 can establish PTT connections with the cellular phones 140 and 150 that belong to the service groups of the server 110 via the cellular phone 130.

In contrast to the prior art, the method of the present invention makes it possible to establish PTT connections among mobile communication devices that belong to different service groups of different servers, and even makes it possible to establish PTT connections between un-registered mobile communication devices without consuming much time and cost for establishing the same standard of PTT service between different servers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for push-to-talk (PTT) over mobile communication devices, the method comprising:
(a) a first mobile communication device directly transmitting a call request signal to a second mobile communication device in a peer-to-peer manner, the first mobile communication device and the second mobile communication device belonging to different servers, wherein the call request signal is requesting for establishing a call;
(b) the second mobile communication device transmitting the call request signal to a first server;
(c) after the first server receiving the call request signal from the second mobile communication device, the first server transmitting a reception authority signal to a third mobile communication device and transmitting a call authority signal to the second mobile communication device, the second mobile communication device and the third mobile communication device belonging to the first server; and
(d) the second mobile communication device directly transmitting the call authority signal to the first mobile communication device.

2. The method of claim 1 further comprising:
(e) the first mobile communication device directly transmitting voice data to the second mobile communication device in a peer-to-peer manner;
(f) the second mobile communication device transmitting the voice data to the first server; and
(g) the first server transmitting the voice data to the third mobile communication device.

3. The method of claim 1 further comprising:
(e) the first mobile communication device directly transmitting a call release signal to the second mobile communication device;
(f) the second mobile communication device transmitting the call release signal to the first server;
(g) after the first server receiving the call release signal from the second mobile communication device, the first server transmitting an idle mode signal to the second mobile communication device and the third mobile communication device;
and
(h) the second mobile communication device transmitting the idle mode signal to the first mobile communication device.

4. The method of claim 3 wherein the first mobile communication device comprises a PTT button, and the method further comprises releasing the PTT button of the first mobile communication device to transmit the call release signal.

5. The method of claim 1 wherein the first mobile communication device comprises a PTT button, and the method further comprises pushing the PTT button of the first mobile communication device to transmit the call request signal.

6. The method of claim 1 wherein the first mobile communication device and the second mobile communication device directly transmit signals to each other according to session initiation protocol (SIP).

7. A method for push-to-talk (PTT) over mobile communication devices, the method comprising:
(a) a first mobile communication device directly transmitting a call request signal to a server;
(b) the server transmitting a call authority signal to the first mobile communication device and transmitting a reception authority signal to a second mobile communication device, the first mobile communication device and the second mobile communication device belonging to the server; and
(c) the second mobile communication device directly transmitting the reception authority signal to a third mobile communication device, the second mobile communication device and the third mobile communication device belonging to different servers in a peer-to-peer manner.

8. The method of claim 7 further comprising:
(d) the first mobile communication device transmitting voice data to the server;
(e) the server transmitting the voice data to the second mobile communication device;
and
(f) the second mobile communication device transmitting the voice data to the third mobile communication device.

9. The method of claim 7 further comprising:
(d) the first mobile communication device transmitting a call release signal to the server;
(e) after the server receiving the call release signal from the first mobile communication device, the server transmitting an idle mode signal to the first mobile communication device and the second mobile communication device; and
(f) the second mobile communication device transmitting the idle mode signal to the third mobile communication device.

10. The method of claim 7 wherein the second mobile communication device and the third mobile communication device directly transmit signals to each other according to session initiation protocol (SIP).
